(19) United States
(12) Patent Application Publication
(10) Pub. No.: US 2025/0373180 A1
(43) Pub. Date: Dec. 4, 2025

(54) ENERGY HARVESTING AND SELF-POWERED SENSING DEVICES UTILIZING NATURAL POROUS MATERIALS

(71) Applicant: THE BOARD OF TRUSTEES OF THE UNIVERSITY OF ILLINOIS, Urbana, IL (US)

(72) Inventors: Yi-Cheng Wang, Champaign, IL (US); Longwen Li, South Bend, IN (US); Zhenhui Jin, Wuxi (CN)

(73) Assignee: THE BOARD OF TRUSTEES OF THE UNIVERSITY OF ILLINOIS, Urbana, IL (US)

(21) Appl. No.: 19/224,108

(22) Filed: May 30, 2025

Related U.S. Application Data
(60) Provisional application No. 63/654,545, filed on May 31, 2024.

(51) Int. Cl. H02N 1/04; B82Y 40/00; H02J 50/00

(52) U.S. Cl. CPC H02N 1/04; B82Y 40/00; H02J 50/001

(57) ABSTRACT

Aspects of the subject disclosure may include, for example, a triboelectric device comprising: a device body including organic material and multiple layers of material, where when mechanical energy is applied to the device body electrical energy is generated. The organic material can be or otherwise include pomelo peel. The pomelo peel can be utilized with a conductive layer and a substrate, and where another triboelectric layer can include a conductive layer and a substrate. The multiple layers of material can include a conductor and an insulator comprising at least one of copper, acrylic, a polyimide film, a PTFE layer, or a combination thereof.

### CROSS-REFERENCE TO RELATED APPLICATION(S)

The present application claims the benefit of priority to U.S. Provisional Application No. 63/654,545 filed on May 31, 2024, which is hereby incorporated herein by reference in its entirety.

### GOVERNMENT SUPPORT

This invention was made with government support under NI22HFPXXXXXG030 and NI23HFPXXXXXG033 awarded by the Department of Agriculture. The United States Government has certain rights in the invention.

### FIELD OF THE DISCLOSURE

The subject disclosure generally relates to energy harvesting and self-powered sensing devices utilizing natural porous materials, such as for triboelectric devices, sensors, or nanogenerators.

### BACKGROUND

Energy sources, particularly utilizing clean energy, are often products that are sought after throughout the world.

Food waste is a serious environmental, social, and economic challenge. Globally each year, about 1.3 billion tons of food are wasted or otherwise lost, and the economic cost of disposing of food waste is around $2.6 trillion. According to the United Nations Food and Agriculture Organization (FAO), global food waste is responsible for about 3.3 gigatons of greenhouse-gas emissions annually. In other words, if food waste were a country, it would rank as the third largest greenhouse-gas emitter, behind only China and the United States.

However, it is believed that some of these economic and environmental impacts could be alleviated by upcycling of food waste: e.g., transforming it into value-added products. More specifically, such practices can directly reduce the financial and space costs of food-waste management; conserve resources; and potentially have other economic benefits, including but not limited to diversification. However, potential methods of food waste upcycling/valorization remain underexplored.

### BRIEF DESCRIPTION OF THE DRAWINGS

Reference will now be made to the accompanying drawings, which are not necessarily drawn to scale, and wherein:

FIGS. 1a-g is a diagram illustrating, among other things, an example fabrication process and characterization of natural porous material such as derived from pomelo peel.

FIGS. 2a-h illustrate a characterization and optimization of the electrical-output performance of pomelo-peel biomass-derived natural porous material-based triboelectric devices.

FIGS. 3a-d illustrate an electrical-output performance characterization of pomelo-peel biomass-derived natural porous material-based triboelectric devices.

FIGS. 4a-i illustrate applications of pomelo-peel biomass-derived natural porous material-based triboelectric devices for harvesting mechanical energy.

FIGS. 5a-h illustrate applications of pomelo-peel biomass-derived natural porous material-based triboelectric devices as biomotion sensors.

FIG. 6 illustrates a method in accordance with various aspects described herein.

### DETAILED DESCRIPTION

The subject disclosure describes, among other things, illustrative embodiments for a triboelectric device/nanogenerator comprising: a device body including organic material and multiple layers of material, whereby when mechanical energy is applied to the device body, electrical energy is generated. In one embodiment, the organic material can be, or otherwise can include, pomelo peel biomass. The multiple layers of material can be, or otherwise can include, copper, acrylic, and a polyimide film. Other polymers can also be utilized, such as polytetrafluoroethylene (PTFE). For example, it can include various materials such as PTFE and polyimide, which can be selected according to various factors including generating a higher signal output as compared to other materials. In other embodiments, copper can be replaced/combined with other conductive material or coating, such as aluminum or indium tin oxide, among others. Additionally, acrylic, used as a substrate, can be replaced/combined with other materials such as paper, Kapton, or other synthetic or biological polymers.

In one or more aspects, a triboelectric device can be provided that includes a device body including organic material and multiple layers of material, where electrical energy is generated responsive to mechanical energy being applied to the device body, and where the electrical energy is utilized for power, as a signal, or both.

In one or more aspects, a method can be provided that includes integrating a triboelectric device into an object that is repeatedly subjected to mechanical energy, where the triboelectric device comprises a device body including organic material and multiple layers of material; and connecting the triboelectric device to an electrical component, where, when the mechanical energy is applied to the device body, electrical energy is generated and provided to the electrical component.

In one or more aspects, a method can be provided that includes obtaining pomelo peel; cut the outer layer of pomelo peel; punching the processed pomelo peel into a particular size and shape resulting in a pomelo disc; freeze drying the pomelo disc; polishing a surface of the pomelo disc; rehydrate the pomelo disc (which may or may not be performed); and combining the pomelo disc with multiple layers of material to create a device body for a triboelectric device. In one embodiment, the freeze-dried pomelo peel can be exposed to different relative humidity levels for rehydration. For example, the degree of rehydration can influence the output performance of the resulting devices. In one embodiment, there can be two parts to the pomelo peel: the green (yellow) outer layer and the white inner layer. As an example, the green layer can be removed in whole or in part and only or substantially only the white part can be utilized for device fabrication. In one embodiment, devices made solely from the green layer had a performance that was inferior compared to those made from the white layer.

Devices (e.g., energy harvesters and/or wearable sensors) can be made with, or of, a porous organic material(s), such as a pomelo-fruit porous material (albedo). In one embodiment, these devices can be used for biomechanical monitoring. For example, in one implementation, the devices can have an open circuit voltage of 58 V and a peak power density of 254.8 mW/m². As another example, these devices can be used as wearable sensors. Other uses are also contemplated.

For example, the organic-based (such as pomelo peel) device can be utilized as a TENG for harvesting ambient mechanical energy from our everyday life (for example, walking or running). Many typical human motions are below 4 Hz but the TENG can convert this mechanical energy into electrical energy.

Many porous materials are non-biodegradable and require non-sustainable syntheses. For instance, the synthesis of porous materials that could be used in TENGs often requires harsh synthetic conditions, toxic and hazardous reagents, etc. Some biodegradable porous materials that could be used in triboelectric devices can also have limitations such as mechanical weakness. However, the porous materials (e.g., albedo) obtained from pomelo fruit does not have these disadvantages.

One or more embodiments described herein can include or utilize a biomass, such as a pomelo peel-biomass, which operates as a natural porous material-based triboelectric nanogenerators (PP-TENG). In one embodiment, the PP-TENG can be operated using a “contact-separation mode” (e.g., layers physically brought into contact via application of external forces, then separated by releasing those forces). The force(s) can be from various directions and combinations of directions including vertical and/or lateral forces. For instance, a polyimide film and pomelo-peel can be used as two triboelectric layers in this example.

It should be understood that other materials, other arrangements, and/or other organic material can be utilized in various embodiments, which may or may not be utilized with the pomelo peel. For example, a single TENG of a larger size may be utilized or multiple TENGs of smaller sizes (including tens, hundreds, thousands, millions, etc.) may be utilized depending on the particular mechanical energy, environment, object being integrated with, and/or other factors. In another embodiment, a combination of different types (e.g., made of different materials), shapes and/or sizes of TENGs can also be used depending on the particular mechanical energy, environment, object being integrated with, and/or other factors. In another embodiment, the organic material can be another type of organic material or biomass that is porous, bio-degradable and/or considered bio-waste.

In one or more embodiments, a method in accordance with various aspects described herein enables a biomass to be utilized to generate energy. As an example, a pomelo-fruit-peel (such as biomass waste which is typically discarded) can be harvested from a pomelo fruit, cut, freeze dried, and polished such as with 100 grit sandpaper (to increase surface smoothness). In one embodiment, the pomelo-peel disks can be stored in a 70% relative humidity chamber for 1 day to rehydrate before use.

Triboelectric nanogenerators (TENGs) have the ability to generate electricity from otherwise-wasted ambient mechanical energy, such as human motion and minor eddies in streams and rivers. Operating through the coupled effects of contact electrification and electrostatic induction, TENGs are more efficient than electromagnetic generators at converting low-frequency mechanical energy (<5 Hz): the range that most wasted ambient energy falls into. This, and their other advantages such as structural simplicity, flexibility in materials selection, and light weight, means that TENGs have a vast range of potential applications, including pathogen control for food safety, sensors, and wearable devices. However, TENGs fabricated from synthetic polymers such as poly(ethylene terephthalate) polyimide and polytetrafluoroethylene, are not biodegradable and are regarded as pollutants if not properly disposed of. Therefore, it can be important to utilize less harmful (and ideally, biodegradable and renewable) materials which might be suitable for TENG construction.

Porous materials, such as foam and aerogels, not only improve TENG's electrical-output performance but also enhance such device's sensitivity to variations in force, thereby expanding their range of potential applications. The specific ingredients used to create some porous materials for TENGs can include polydimethylsiloxane, poly(p-phenylene benzobisoxazole), and cellulose, among others. However, most of these porous materials are either based on synthetic polymers or require complex synthesis processes that would be a barrier to their widespread adoption for this purpose. Hence, it is beneficial to utilize porous materials from sustainable sources for use as triboelectric layers in these devices.

Hydrogels have also been used in TENG fabrication; but to date, they have been deployed as conductive layers, i.e., electrodes, and not as triboelectric layers. Hydrogels facilitate TENGs flexibility and/or stretchability rather than their output performance.

Pomelo fruit (Citrus maxima), also known as pummelo or shaddock, is widely cultivated and consumed worldwide, with 9.4×10⁶ tons produced annually. A pomelo fruit can weigh between 1 and 2 kg, of which the peel (the thickest and largest of any citrus fruit) accounts for 30-50%. An enormous amount of waste is therefore generated by fresh pomelo production, consumption, and juice-making.

Valorization/upcycling of these fruits' peels has the potential to vastly reduce such waste. As the main components of pomelo-peel biomass are cellulose, hemicellulose, and bioactive compounds, it can be a source of pectin, essential oils, and activated carbon. Additionally, however, pomelo-peel biomass naturally exhibits a three-dimensional porous structure that not only sets it apart from other types of fruit and vegetable waste but also endows it with a high specific surface area, excellent mechanical properties, and low density. There also exists the possibilities of leveraging such properties for applications such as solar-thermal materials and adsorbents. One or more of the exemplary embodiments can utilize pomelo-peel biomass to fabricate TENGs.

An approach to the fabrication of TENGs is provided in one embodiment, in which a natural porous material derived from pomelo-peel biomass is used as one of the two triboelectric layers in each such device. If coupled with effective design and optimization, this natural material's preexisting three-dimensional porous structure means that pomelo peel biomass-derived natural porous material-based TENGs (PP-TENGs) can have excellent abilities to harvest ambient energy from various kinds of motions and to sense a range of different biomechanical motions. As such, these devices provide new possibilities for transforming a prolific type of food waste into value-added products, thus reducing such waste and enhancing sustainability.

In one or more embodiments, preparation of natural porous materials can be derived from various substances such as pomelo-peel biomass. The fresh pomelos used can, prior to being processed, be rinsed, such as with Milli-Q water from a Direct-Q water-purification system. Then, pomelo peels can be separated (e.g., manually or automatically) from pomelo flesh/pulp, and an instrument (e.g., a knife) can be used to separate the outermost, greenish peel, known as flavedo, from the albedo: the thick, spongy white peel, which typically accounts for the majority of the volume of the pomelo peel. The natural porous material can be derived from albedo only or in other embodiments from other sources. To improve the uniformity of the porous-material samples, the thinnest and thickest parts of the albedo can be trimmed off. Next, circular or other-shaped cutters of various sizes can be employed to “punch” the resulting irregularly shaped albedo samples, thus creating circular (or other desired shapes) ones, which can have the same or varying diameters/sizes/shapes. Then, the samples can be cut into slices of the same or different thicknesses. Other techniques can also be utilized.

In one embodiment, freeze-drying can be employed (although in other embodiments other techniques can be utilized including hot-air drying) for retaining the porous structure of cellulosic materials, after which they can be otherwise processed including polishing such as using sandpaper or other tools to increase surface smoothness. In one embodiment, the resultant disc-shaped samples can have diameters of 10, 20, or 30 mm and thicknesses of 2, 3, or 4 mm, although other shapes and sizes can be utilized depending on the intended use of the TENG, including as an energy harvester, monitoring sensor and so forth. Following their initial preparation, the pomelo-peel samples can be stored, such as for 24 h at a desired relative humidity (RH) levels. In one embodiment, different RH levels were used, i.e., 16%, 33%, 55%, 75%, and 99%. Herein, the resulting samples that are derived from pomelo-peel biomass, may be referred to as the “natural porous material.”

The chemical and physical properties of freeze-dried natural porous material samples can be characterized using various methods. Their surface morphologies can be examined with an environmental scanning electron microscope operating at an accelerating voltage of 10 kV. Their specific surface areas can be measured via nitrogen adsorption-desorption analysis. Their isotherms' Brunauer-Emmett-Teller (BET) specific surface areas can then be determined, such as using Gemini VII software. The biodegradability of the freeze-dried samples can be evaluated by placing them on the surface of soil, such as in 4 cm radius circular pots for 3 weeks and weighing them on days 5, 10, 15, and 21 (or other time periods). The thermal stability of the samples can be evaluated using a thermogravimetric analyzer in a nitrogen atmosphere, at various temperatures such as ranging from 25 to 500° C. Chemical analysis of the natural porous materials can be performed using Fourier transform infrared spectroscopy such as with a test resolution of 0.4 cm⁻¹ and a sample-test wavelength range of 400 to 4000 cm⁻¹. The mechanical properties of the samples can be assessed using an electromechanical test system.

Polyimide film (such as Kapton®) and natural porous material can be used as the two triboelectric layers in PP-TENGs, all of which can operate in contact-separation mode: i.e., the layers are brought into contact via the application of external forces and separated via the releasing of such forces. However other layers can be utilized with or without Kapton and/or pomelo peel. To systematically characterize the triboelectric performance of the PP-TENGs, one copper (Cu) foil electrode can be first adhered to each of the two triboelectric layers. In one embodiment, two main component combinations for PP-TENGs can be a) Kapton with copper foil, and b) pomelo peel with copper foil. In one or more embodiments, multiple layers can be utilized. Then, those two layers can be placed on a design-testing system that includes a linear motor that provides controllable and programmable mechanical motion and a force sensor that measures the force applied. Next, these conductive layers can be connected to an electrometer to characterize the devices' open-circuit voltage (V_{oc}), short-circuit transfer charge (Q_{sc}), and short-circuit current (I_{sc}). Natural porous material samples with the above-mentioned diameter/thickness combinations can be tested to ascertain if/how such parameters affect triboelectric performance. Evaluation of such performance can be before vs after the samples received sandpaper treatment. This evaluation can then be used to select, design and/or fabricate TENGs for various uses including as energy harvesters and motion sensors.

In one embodiment, PP-TENGs' can be used for biomechanical monitoring, such as natural porous material samples being incorporated into wearable sensors/systems, including for joint- and neck-motion monitoring. In one embedment of fabricating a triboelectric device (or a portion thereof), first, Cu foil can be adhered to one side of a natural porous material sample and one side of a Kapton sample. Then, pairs of these two types of triboelectric layers can be placed on two separate flexible plastic baseboards made of Kapton and separated from each other with spacers, allowing them to operate in contact-separation mode. A cloth bandage can be used to ensure that the sensors fit securely and stably on the relevant area of the human body. All the flexion angles can be measured using an angle protractor for testing purposes. For gait monitoring, a 30 mm diameter, 2 mm thick sample of natural porous material, backed with a conductive layer, can be adhered to clothing such as a sock worn by a subject, a shoe and so forth. Other triboelectric layers of other sizes and shapes can be employed such as at the insole of that person's shoe or sandal.

To analyze performance, statistical analysis of the data yielded by the above embodiments was conducted with one-way analysis of variance (ANOVA) using SPSS software. COMSOL Multiphysics software was also used to simulate the electrical potential of different triboelectric layers at different separation distances.

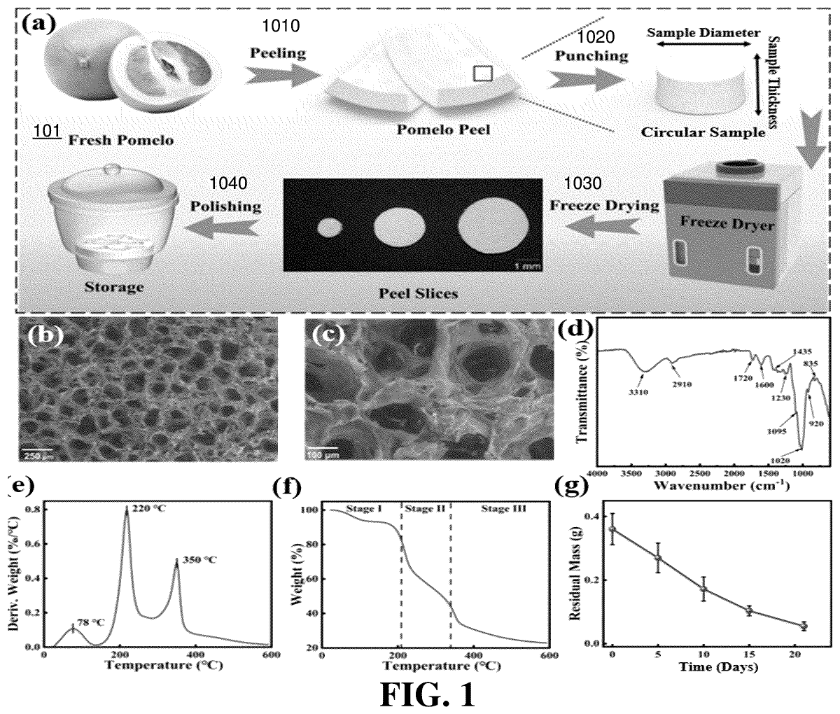

FIGS. 1a-g illustrate a fabrication process and characterization of natural porous material derived from pomelo peel. FIG. 1a illustrates a process 101 for processing pomelo-peel samples. For example at 1010 pomelo-peel can be rinsed, peeled and cut. At 1020, circular or other-shaped cutters of various sizes can be employed to “punch” the resulting irregularly shaped albedo samples, which can have the same or varying sizes, diameters and/or shapes. At 1030, drying such as freeze-drying can be employed. At 1040, other processing can be employed, such as polishing using sandpaper or other tools to increase surface smoothness. Following their initial preparation, the pomelo-peel samples can be stored for a particular time period at a desired relative humidity (RH) levels resulting in natural porous material for use in triboelectric generators.

FIGS. 1b-c are SEM images (e.g., at two different magnifications) of natural porous material samples that reveal their naturally occurring porous structures. Their distinct and well-developed pores are the basis of their large specific surface area, a property that can greatly improve triboelectric performance.

FIG. 1d illustrates Fourier transform infrared spectroscopy spectrum of the freeze-dried natural porous material. FIGS. 1e-f illustrate thermogravimetric analysis of the natural porous material's derivative weight change and weight change, respectively. FIG. 1g illustrates results of testing of the natural porous materials' biodegradability.

In one or more of the embodiments, nitrogen adsorption desorption testing indicated that the natural porous material samples' BET specific surface area was 4.93+/−2.35 m²g⁻¹ (n=3), which also confirms the SEM results. In addition to pomelo peel's substantial surface area-to-volume ratio, the abundant voids in its structure may be charge-capture sites. They might be instrumental in modulating the dielectric constant and in helping mitigate charge decay on the dielectric surface. Collectively, these two factors can be expected to boost the electrical output of PP-TENGs.

As briefly noted above, pomelo peels are rich in cellulose, hemicellulose, lignin, and pectin, and thus their surfaces abound with carboxyl, hydroxyl, and other functional groups. FIG. 1d shows the results of FTIR: i.e., peaks located at 3310, 2910, 1720, 1600, 1435, 1230, 1095, 1020, 920, and 835 cm⁻¹, each of which corresponds to a specific vibrational mode. The broad band at 3310 cm⁻¹ could signify the stretching vibration of the hydroxyl (OH) groups, while the peak at 2910 cm⁻¹ may correspond to the stretching vibration of the C—H in cellulose chains, and the one at 1600 cm⁻¹ could reflect the stretching vibration of the —C═O in lignin. The peak at 1435 cm⁻¹ may be associated with carboxyl groups. The peak at 1720 cm⁻¹ may be attributable to the stretching vibration of the carbonyl (C═O) groups, potentially associated with hemicellulose and lignin, and a relatively weaker peak at 1230 cm⁻¹ could be associated with C—O stretching vibration.

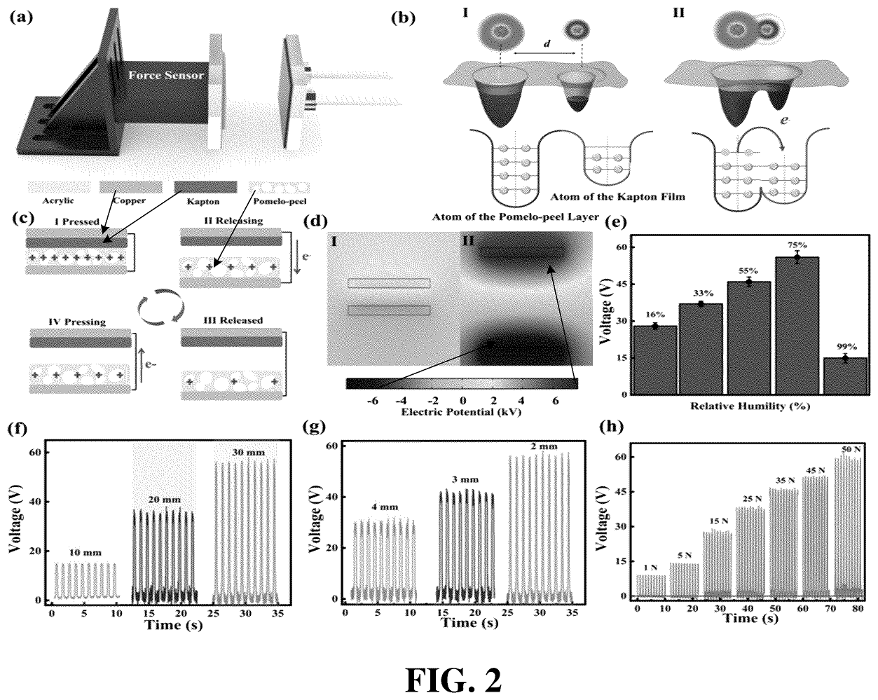

FIGS. 2a-h illustrate characterization and optimization of the electrical-output performance of pomelo-peel biomass-derived natural porous material-based triboelectric nanogenerators (PP-TENGs). In one or more embodiments, FIG. 2a shows a schematic of fabrication and/or testing for a PP-TENG, consisting chiefly of electrode A and electrode B, with pomelo-peel biomass-derived natural porous material and Kapton film as their respective triboelectric layers. A linear motor and a force sensor were also included in the testing system. FIG. 2b shows a schematic of an electron-cloud potential-well model of the PP-TENG. FIG. 2c shows the working mechanism of a PPTENG. FIG. 2d shows a COMSOL simulation of the electrical potential of the pomelo-peel biomass-derived natural porous material and Kapton layers at two separation distances. FIG. 2e shows a voltage output of the PP-TENGs whose pomelo-peel biomass samples were pretreated via storage at various relative humidity levels. FIG. 2f shows an open-circuit voltage (V_{oc}) of PP-TENGs made with pomelo-peel biomass-derived natural porous material samples of different diameters (10, 20, and 30 mm). FIG. 2g shows V_{oc} of PP-TENGs made with pomelo-peel biomass-derived natural porous material samples of different thicknesses (4, 3, and 2 mm). FIG. 2h shows V_{oc} of the optimized PP-TENG under applied forces of 1, 5, 15, 25, 35, 45, and 50 N.

It is believed that the presence of hydroxyl compounds may be in the natural porous material. The stretching vibration of the C—O—C in hemicellulose or cellulose molecules could be the source of the peaks observed at 1095 and 1020 cm⁻¹. Lastly, the peaks at 920 and 835 cm⁻¹ could be related to β-glycosidic linkage. Thermogravimetric analysis (TGA) results (FIGS. 1e-f) indicate that the natural porous material had good stability at room temperature. The minor mass loss observed at temperatures below 100° C. might be attributable to the evaporation of water previously sorbed by the sample; and weight loss, in the temperature range of 220 to 350° C., to the thermal depolymerization of hemicellulose, cleavage of cellulose's glycosidic linkages, and depolymerization of pectin macromolecules. In the third phase of decomposition, from 350 to 550° C., significant breakdowns of cellulose and hemicellulose could take place, and lignin could begin to carbonize, and this would tend to lead to the decomposition of a majority of the compounds on the tested natural porous materials' surfaces. These characteristic peaks reflect the diversity of functional groups and chemical components that are present in the natural porous materials. The abundance of functional groups such as hydroxyl ones can potentially endow a material with an electron donating property, which makes it a good candidate for use as a positive material in triboelectric applications. Additionally, since it can be derived from fruit, the natural porous material(s) would be biodegradable. When placed on the surface of soil, their weight decreased gradually to around 10% of its initial value over 21 days (FIG. 1g). These results not only confirm these materials' biodegradability but also imply their strong potential as replacements for synthetic counterparts.

Generally, freeze-dried pomelo-peel samples are rigid and therefore do not respond to force sensitively. Therefore, in one embodiment, a selection of freeze-dried samples were treated by storing them at various RH levels for at least 24 h and then analyzed to identify their mechanical properties. Samples stored at higher RH levels became less stiff, suggesting that they could respond more sensitively to force. Notably, storage at 75% RH for at least 24 h endowed samples with flexibility, e.g., an ability to return to their original shapes after repeated bending and twisting.

FIG. 2a illustrates a testing system, and FIG. 2b illustrates the fundamental mechanisms of contact electrification. Before the natural porous material and Kapton come into contact, their respective electron clouds constituted by outer-shell electrons in both types of material maintain a separation distance of d. These electrons are loosely bonded to their respective atomic structures (FIG. 2b-I). When the two materials contact each other, their electron clouds overlap, allowing electron migration between materials, leading to electrification (FIG. 2b-II). Due to the disparity in electron affinity between the two materials, the Kapton demonstrates an enhanced propensity to withdraw electrons, and atoms within the natural porous material are predisposed to relinquish electrons to the Kapton.

Similarly, as depicted in FIG. 2c-I, when the two triboelectric materials come into contact, equal and opposite triboelectric charges are generated on their surfaces due to the above-mentioned phenomenon of overlapping electron clouds. Specifically, positive triboelectric charges appear on the natural porous material layer, while negative charges are present on the Kapton layer. When the force is reversed (FIG. 2c-II), as the separation distance between the natural porous material layer and the Kapton layer increases, electrons flow from the Cu layer attached to the Kapton to the Cu layer attached to the natural porous material through the external circuit, to balance the electric field that has built up due to the triboelectric charges. This process continues until it reaches a state of saturation (FIG. 2c-III) or the device attains its designed maximum separation distance.

The simulation results in FIG. 2d also show that, as the distance between the two triboelectric layers increases, potential difference also increases. When force is reapplied (FIG. 2c-IV), the electrons flow back i.e., away from the Cu attached to the natural porous material and into the Cu attached to the Kapton forming a current in the opposite direction, until the two triboelectric layers return to contact with each other (FIG. 2c-I). These mechanisms can be used to repeatedly convert mechanical motions into electrical output.

FIG. 2e illustrates the output performance of PP-TENGs whose materials were pretreated via storage at varying RH levels. It shows that up to a point, these devices' voltage output increased with rising humidity: i.e., from around 28 V at 16% RH to 37V at 33% RH, 46V at 55% RH, and 56V at 75% RH. However, output plummeted to about 15V when pretreatment RH was 99%.

To identify explanations of these phenomena, FTIR can be used to characterize natural porous material samples that have been pretreated at each RH level. In one example, the O—H stretching vibration peak of those samples stored at 16% RH was at 3310 cm⁻¹. At higher pretreatment RH levels of 33, 55, 75, and 99%, the same peak's wavenumbers were lower: i.e., 3291, 3285, 3277, and 3265 cm⁻¹, respectively. Such differences could be attributable to enhanced hydrogen-bonding interactions between cellulose in the material and water molecules, and the same interactions might also explain the relevant TENGs' increased output. Nonetheless, excessively high humidity (in this case, 99% RH) can cause the sorption of excessive water molecules on the surfaces, potentially leading to neutralization of charges during subsequent contacts, and if so, decreasing the triboelectric output of the resulting TENGs. In one embodiment, based on these results, natural porous material samples can be selected including ones that are preconditioned at 75% RH. In other embodiments, surface smoothness, diameter, and/or thickness of natural porous material samples can affect PP-TENGs' output. For example, after polishing with sandpaper, a marked increase in V_{oc} has been observed. This is likely attributable to the sandpaper treatment smoothing out the uneven surface of the natural porous material samples, thereby enlarging their area of contact with the Kapton. FIG. 2f presents the V_{oc} data for PP-TENGs fabricated with natural porous material samples of three different diameters. Under a compressive force of 50 N and a frequency of 1 Hz, V_{oc} (as well as I_{sc}, and Q_{sc}) became significantly higher (p less than or equal to 0.01) as the diameter of the samples increased from 10, to 20, to 30 mm. The PP-TENGs made of natural porous materials with a diameter of 30 mm achieved a V_{oc} of 58 V, an I_{sc} of 1.8 μA, and a Q_{sc} of 23 nC_in line with previous findings that a larger contact area tends to lead to more charge being generated.

A relationship exists between the thickness of natural porous material discs and the electrical-output performance of PP-TENGs made from them. As thickness decreased from 4 mm, to 3 mm, to 2 mm, V_{oc}, Q_{sc}, and I_{sc} all increased significantly (p less than or equal to 0.01) under the same force and frequency conditions noted above. This phenomenon could have resulted from greater sample thickness diminishing electrostatic induction. Having arrived at a particular sample diameter and thickness (e.g., improved or optimal), PP-TENGs' V_{oc} responsiveness can be determined according to various forces such as ranging from 1 to 50 N. The results indicated these devices' exceptional sensitivity to applied force, with V_{oc} exhibiting linear increases as the applied force increased (FIG. 2h). This corresponds to a sensitivity of 0.94 V N⁻¹. Such high sensitivity to mechanical forces can partially be attributed to the three-dimensional structure of the natural porous material.

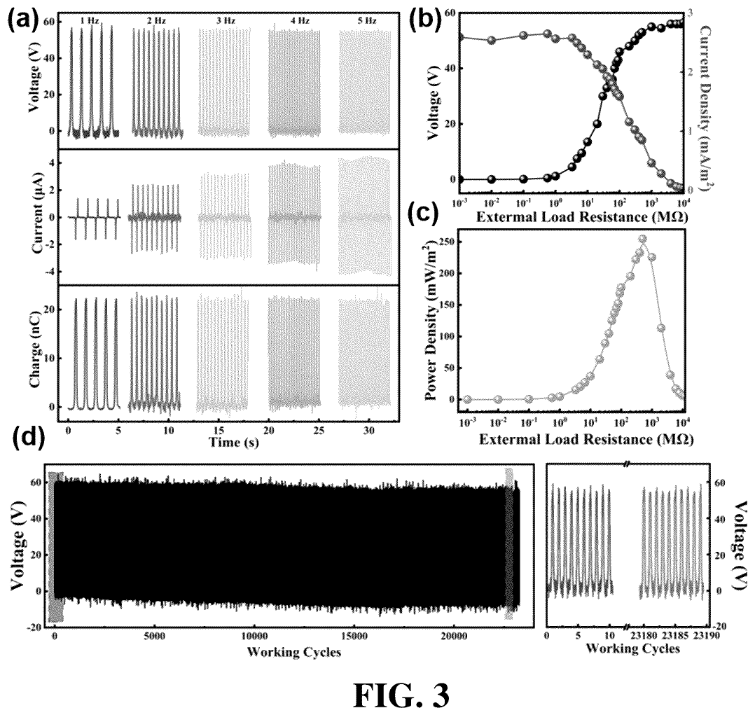

FIG. 3a shows the V_{oc}, I_{sc}, and Q_{sc} of PP-TENGs operating at different frequencies. As frequency increased from 1 to 5 Hz, V_{oc} and Q_{sc} both exhibited negligible differences, but I_{sc} increased from 1.8 to 4.5 μA. Current (I) can be derived using eq 1:

I=dQ/dt (1)

where dt represents the time needed for one cycle of charge transfer and dQ to the amount of charge transferred during one cycle. Thus, an increase in frequency will decrease dt, resulting in a higher value of I. PP-TENGs' output performance was further evaluated using various external-load resistors (FIG. 3b). As resistance increased from 1 k-ohm to 1 G-ohm, output voltage also increased. However, when resistance increased further (from 1 G-ohm to 10 G-ohm), output voltage remained unchanged, at around 58 V. This might be due to the resistance having become so large that the circuit approached an open-circuit state. Conversely, current output decreased with increasing resistance. A maximum instantaneous power density of 254.8 mW m⁻² was achieved at a load resistance of approximately 500 M-ohm (FIG. 3c). The formula used for calculating output-power density was:

P=I²R/S (2)

where P is power density; I is the output current on the external load; R represents the load resistance; and S represents the contact area of the natural porous material layer, calculated from its diameter.

FIGS. 3a-d illustrate electrical-output performance characterization of pomelo-peel biomass-derived natural porous material-based triboelectric nanogenerators (PP-TENGs). FIG. 3a shows an open-circuit voltage, short-circuit current, and short-circuit charge under a 50 N force with different working frequencies. FIG. 3b shows a current density and voltage output of PP-TENGs under different external-load resistances. FIG. 3c shows a power density of PP-TENGs under different external load resistances. FIG. 3d shows a stability test of a PP-TENG's performance across 25,000 cycles.

A key metric of TENGs' quality is stability. FIG. 3d shows the results of stability testing of a PP-TENG over more than 25,000 cycles of continuous operation. Specifically, the V_{oc} of this device remained at about 95% of its initial value after such operation, indicating excellent long-term stability.

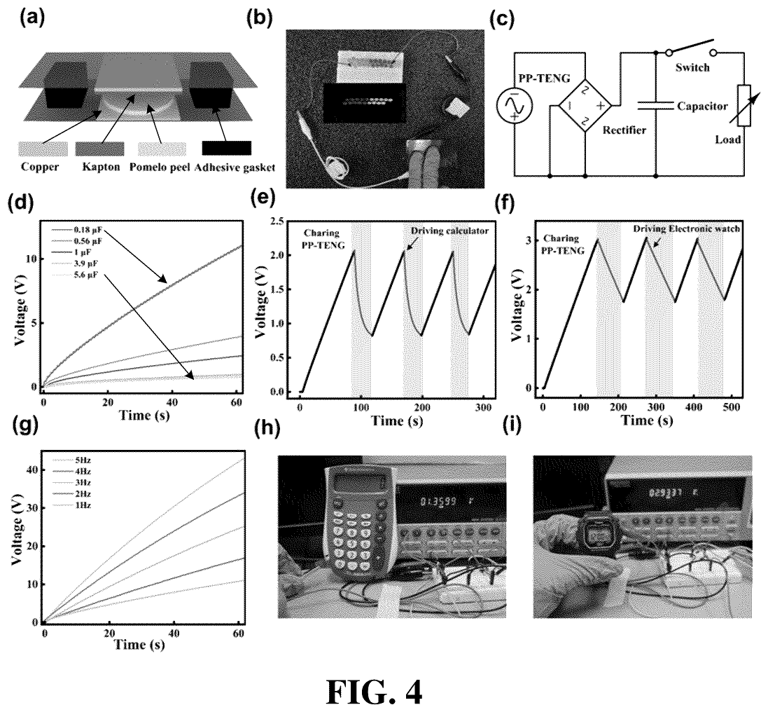

In an example if fabricating and evaluating triboelectric device such as PP-TENGs' energy-harvesting capabilities, FIG. 4a illustrates one including copper layers, a piece of natural porous material (shortened to “pomelo peel” in the figure), Kapton layers, and adhesive gaskets. As depicted in FIG. 4b, a simple finger-tap on this PPTENG generated an output sufficient to illuminate 20 light emitting diodes (LEDs). Given that mechanical energy from the ambient environment is often intermittent, this device can be provided with a power-management circuit consisting of an energy-storage unit (i.e., capacitor) and a rectifier, as shown in FIG. 4c. The alternating current generated by the PP-TENG can be converted into direct current through the rectifier and then stored in the capacitor. FIG. 4d illustrates that under the same external stimuli, capacitors of 0.18, 0.56, 1, 3.9, and 5.6 μF achieved voltages of 11, 4, 2, 1, and 0.8 V, respectively, over 60 s of operation. This suggests that capacitors with smaller capacitance can be charged faster by such devices under a given set of operating conditions. Moreover, increasing the operational frequency of PP-TENGs also led to faster charging speeds (FIG. 4g).

FIGS. 4a-i illustrate applications of pomelo-peel biomass-derived natural porous material-based triboelectric nanogenerators (PP-TENGs) for harvesting mechanical energy. FIG. 4a shows a schematic of a PP-TENG. FIG. 4b shows a PP-TENG, driven by finger tapping, lighting up 20 light-emitting diodes. FIG. 4c shows a circuit through which a PP-TENG charged a capacitor and powered electronics. Charging capability of the PP-TENG is shown in FIG. 4d using capacitors with different capacitance (0.18-5.6 μF) and FIG. 4g under different working frequencies (1-5 Hz) for a capacitor with 0.18 μF. Voltage curves are shown in FIGS. 4e-f for the use of a PP-TENG to power a commercial calculator and an electronic watch, respectively. FIGS. 4h-I show photos of a commercial calculator and an electronic watch being powered by a PP-TENG.

Electrical energy harvested by PP-TENGs and stored in their capacitors can successfully power commercial electronics. As shown in FIG. 4e, PP-TENGs charged a 10 μF capacitor to 2 V in about 83 s, after which the system was activated, allowing the capacitor to discharge and drive a commercial calculator. Using the same setup, it took about 140 s for the PP-TENG to charge the capacitor to a voltage sufficient to power an electronic watch, i.e., 3 V. As such, PP-TENGs have considerable potential to reduce the high resource cost and negative environmental effects of modern society's current use of vast numbers of small batteries.

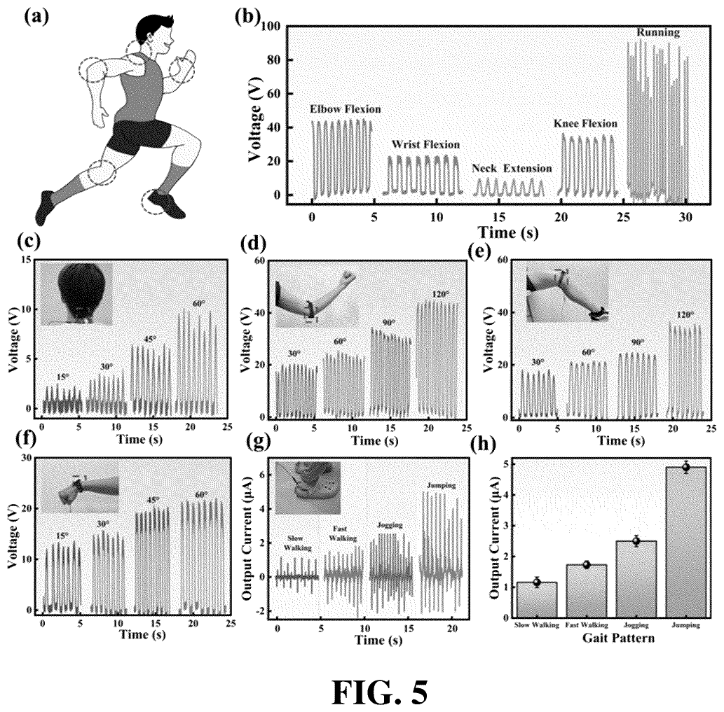

In one or more embodiments, PP-TENGs can be used as self-powered biomechanical-motion sensors. As the electrical output of PP-TENGs is responsive to external force, they can be good candidates for monitoring biomechanical motions. For example, PP-TENGs can operate as self-powered sensors and be placed on various parts of the human body, including the elbow, wrist, posterior of the neck, knee joint, and sole of the foot (FIG. 5a), all of which can produce physiological signals that may be relevant to the diagnosis and/or treatment of certain illnesses. As shown in FIG. 5b, a PP-TENG-based sensor (hereafter, “PP-TENG sensor”) was able to generate distinctive, stable voltage outputs from the movements of all these body parts, with maxima of around 41 V (elbow), 22 V (wrist), 10 V (neck), 34 V (knee), and 86 V (sole), demonstrating the potential for real-time self-powered biomechanical-motion sensing. The electrical outputs that resulted from various flexion/extension angles of these areas, and from gait patterns, are displayed in FIGS. 5c-g.

FIGS. 5a-h illustrate applications of pomelo-peel biomass-derived natural porous material-based triboelectric nanogenerators (PP-TENGs) as biomotion sensors. FIG. 5a shows body parts for monitoring and FIG. 5b is the corresponding signals of various body motions detected using PP-TENG sensors. PP-TENG sensors can be used to monitor motions or movement from the (c) posterior neck (d) elbow, (e) knee, and (f) wrist, along with (g) gait, and their corresponding electrical outputs. Insets are photos of PP-TENGs applied in various positions. FIG. 5h shows a short-circuit current of a PP-TENG sensor exposed to different human gait patterns.

The posterior triangle or lateral cervical area of the human neck contains many muscles. Poor posture, such as maintaining an excessive neck-extension angle or other circumstances that cause a person to hold this area in an improper position, may result in painful conditions. Hence, monitoring an appropriate neck posture is important for the prevention of related health concerns. As shown in FIG. 5c, when PP-TENG was placed on the posterior of a person's neck, repeated motion with 15, 30, 45, and 60 degrees neck extension angles (i.e., the angle between the head and trunk, when the head is extending backward) led to different voltage outputs. That is, voltage increased linearly with neck-extension angles, suggesting this device's considerable potential not only for real-time posture monitoring but also as a preventive-medicine tool for the early detection of neck related problems.

Knees function as weight-bearing joints and play a crucial role in both bearing the body's weight and facilitating diverse ranges of motion. Overuse of the knee or improper posture can lead to pain, stiffness, and/or decreased mobility. Accurate analysis of knee flexion/extension is therefore crucial to the assessment of knee-related disorders. As depicted in FIG. 5e, as the knee flexion angle increased from 30 to 60 to 90 to 120 degrees, the output voltage of the PP-TENG escalated, showing this device's usefulness for real-time monitoring including of knee movements, whether to diagnose abnormal posture or during rehabilitation. The elbow, an intricate synovial joint, facilitates substantial movement and primarily fulfills its function through extension and flexion actions. Overuse of the elbow can cause pain. As FIG. 5d shows, the PP-TENG sensor provided differential voltage outputs corresponding to repeated motion to/from angles of 30, 60, 90, and 120 degrees between the upper arm and the forearm, such that it is capable of facilitating early intervention and treatment to prevent damage to this joint.

The joint complex connecting the forearm to the hand should be maintained in a posture that will not exacerbate compression, as an improper posture causes disorders such as carpal-tunnel syndrome, characterized by numbness and tingling in the hand and arm. As shown in FIG. 5f, the PP-TENG generated voltages corresponding to changes in wrists' flexion angles, suggesting that potentially in combination with recording and/or analysis systems, it could be used to identify abnormal patterns of wrist activity.

As an example, PP-TENGs have other potential healthcare-monitoring applications other than for joint- and neck-area motion, such as gait-monitoring capability. Specifically, in one example, a 30 mm round natural porous material sample with a conductive layer can be affixed to a sock worn by a subject who then puts on a sandal or other footwear, the insole of which serves as the other triboelectric layer. When the wearer takes a step, the natural porous material would come into contact with the insole of the sandal, causing contact electrification. Different motion patterns such as slow walking, fast walking, jogging, and jumping tend to cause different movement frequencies and forces to be applied to the foot. Therefore, as PP-TENG sensors can respond to both the frequency and the quantity of external mechanical force, they are highly suitable for monitoring gait patterns. As can be seen from FIG. 5g, the PP-TENG sensor generated I_{sc} values (and corresponding frequencies) of approximately: 1.2 μA (1.2 Hz), 1.7 μA (1.9 Hz), 2.5 μA (3.2 Hz), and 4.9 μA (2.1 Hz) for slow walking, fast walking, jogging, and jumping, respectively. It should be understood that the TENG sensors can be utilized with other devices (including integrated with a wearable sensor housing having a transceiver) for collecting motion data of a wearer.

These results suggest that electrical-output and frequency data obtained from PP-TENGs could enable real-time gait monitoring for the early detection of various diseases. For example, gait alterations are a common symptom of Parkinson's disease, which is typically characterized by smaller steps, slower walking speeds, and unstable gait, among other symptoms. Such TENG devices not only may provide detailed information about patients' gaits but also may assist physicians in assessing the severity of symptoms and/or the efficacy of treatment regimens. PP-TENG sensors also have potential for various applications in addition to healthcare monitoring. These might include sports-performance analysis, physical rehabilitation, gaming, human-machine interaction, and intelligent control. As described herein, the TENG sensors can be part of a system that includes various devices, including wireless devices for transmitting data, server or computing devices for analyzing the data, and so forth.

In one or more embodiments, the design, fabrication, and use of TENGs is provided such that each utilizes a biomass (such as pomelo-peel biomass-derived natural porous material) as one of their two triboelectric layers, with the other being Kapton, although other layers or materials can be utilized in some embodiments as described above. The freeze-dried natural porous material can be characterized using various methods including ESEM, TGA, FTIR, and nitrogen adsorption-desorption analysis, where such methods can facilitate selecting materials, designs, and so forth for various applications and usages. As freeze-dried pomelo samples are rigid, in some embodiments, they can be treated including via storage at various RH levels for various time periods, such as at least 24 h. Determining their resulting chemical and mechanical properties can further facilitate selecting materials, designs, and so forth for various applications and usages including for energy harvesting and motion monitoring. The results show that such treatment can endow them with flexibility, which can make them respond to force more sensitively. It is also worth noting that although moisture tends to evaporate over time, a simple encapsulation of the resulting triboelectric devices may mitigate that issue.

In one embodiment, once its chemical and physical properties are understood, differences in triboelectric performance at different sizes, thicknesses, and surface-smoothness levels can be leveraged for different applications for the TENGs, such as motion monitoring versus energy harvesting. For example, PP-TENGs' V_{oc} can increase significantly as the diameter of the natural porous material increased from 10 mm to 20 mm to 30 mm, and as its thickness decreased from 4 mm to 3 mm to 2 mm. V_{oc} may also increase significantly after the natural porous material is polished with sandpaper to increase its surface smoothness. Uniquely, probably due to pomelo peel's porous structure, a PP-TENG demonstrated a sensitive response of 0.94V N⁻¹ to external forces ranging from 1 to 50 N. With the help of a power-management circuit such as one that includes a rectifier and capacitor, a PP-TENG can light up LEDs and power portable electronics such as a calculator, sports watch, wearable electronics, and so forth, and that PP-TENG sensors can effectively monitor elbow, wrist, and knee-joint motions, movements of the posterior neck area, gait patterns, as well as other movements or motions, whether these are human motions or otherwise. These results imply that such devices not only can reduce the financial and environmental cost of replacing and disposing of the myriad batteries used in portable electronics but also that they can be used for healthcare monitoring, physical rehabilitation, and human-machine interaction, among other applications. In one or more embodiments, there is a strong potential for transforming a common type of food waste into value-added devices, potentially helping to alleviate the negative impact of such waste and contributing to overall sustainability.

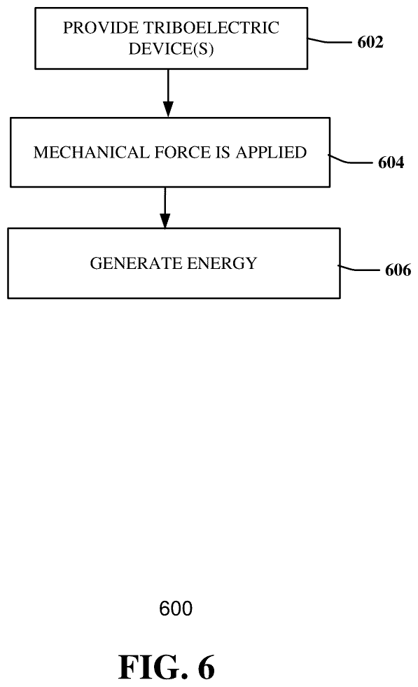

Referring to FIG. 6, a method 600 is illustrated that can be utilized for generating energy, which can be used in a number of different ways including for energy harvesting and/or for monitoring. At 602, a triboelectric device is provided. The triboelectric device can be of any of the types described herein. For example, a triboelectric device can be integrated into an object that will be repeatedly subjected to mechanical energy. Further, the triboelectric device can include a device body having organic material and multiple layers of material. The triboelectric device can be connected to an electrical component. At 604, mechanical energy is applied to the device body and at 606 electrical energy is generated and provided to the electrical component responsive to application of the mechanical energy.

In one embodiment, the organic material comprises pomelo peel. In another embodiment, the multiple layers of material comprise copper, acrylic, and a polyimide film. In another embodiment, the electrical component stores the electrical energy as a signal. In another embodiment, the signal can be analyzed, including by the worn sensor or by another computing device that receives the signal (e.g., via wireless communication) to detect motion of a user that is wearing the TENG (or a wearable object to which the triboelectric device has been incorporated). In another embodiment, operations of the electrical component can be powered by the electrical energy. In one embodiment, the triboelectric device can include an interface for connecting to an electrical component such as an electrical circuit, power management circuit or other components. In one embodiment, the electrical component can include a readout device or a monitor that displays the signal (e.g., read or displays the received signal. In one embodiment, the signal(s) can be analyzed to detect motion or movement of a user that is wearing the object or any other motion of any other entity whether human or not, and can include any characteristics of such motions/movements, such as angles, frequencies, and other related parameters.

In one embodiment, a pomelo peel with a conductive layer can be attached directly to a shoe, sock or other structure for motion monitoring. In one or more embodiments, no additional substrate is required, as the shoe, sock or other structure can serve as the substrate. In other embodiments, the ground can act as the second triboelectric layer in such cases. In some embodiments, a separate substrate is not utilized. In some embodiments, other materials, such as the ground, user fingers, or similar surfaces, can serve as the second triboelectric layer.

In one or more embodiments, one or more of the following alone or in combination can be utilized: the organic material comprises pomelo peel, the pomelo peel is utilized with a conductive layer and/or a substrate, another triboelectric layer includes a conductive layer and a substrate, and/or one or more spacers are utilized to separate different triboelectric layers. In one or more embodiments, spacers can be utilized between layers including between triboelectric layers and/or including adhesive layers. These layers can be made of various materials to facilitate the operation of the triboelectric device.

While for purposes of simplicity of explanation, the respective processes are shown and described as a series of blocks in FIG. 6, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Any use of the terms “first,” “second,” and so forth, in the claims, unless otherwise clear by context, is for clarity only and doesn't otherwise indicate or imply any order in time. For instance, “a first determination,” “a second determination,” and “a third determination” does not indicate or imply that the first determination is to be made before the second determination, or vice versa, etc.

While various components have been illustrated as separate components, it will be appreciated that multiple components can be implemented as a single component, or a single component can be implemented as multiple components, without departing from example embodiments.

Unless otherwise explained, all technical and scientific terms used herein have the same meaning as commonly understood by one of ordinary skill in the art to which a disclosed disclosure belongs. In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, “comprising” is synonymous with “including,” “containing,” or “characterized by,” and is inclusive or open-ended and does not exclude additional, unrecited elements or method steps. For instance, “comprising A or B” means “including A” or “including B” or “including A and B.” As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein suitably may be practiced in the absence of any element or elements, limitation or limitations which is not specifically disclosed herein.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

The disclosure may be further understood by the included non-limiting examples. All references cited herein are hereby incorporated by reference to the extent not inconsistent with the disclosure herewith.

Although the description herein contains many specificities, these should not be construed as limiting the scope of the disclosure, but as merely providing illustrations of some of the presently preferred embodiments of the disclosure. Thus, the scope of the disclosure should be determined by the appended aspects and their equivalents, rather than by the examples given.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure. Thus, it should be understood that, although the present disclosure has been specifically disclosed by preferred embodiments, exemplary embodiments, and optional features, modification and variation of the concepts herein disclosed may be resorted to by those skilled in the art, and that such modifications and variations are considered to be within the scope of this disclosure as defined by the appended aspects. The specific embodiments provided herein are examples of useful embodiments of the present disclosure and it will be apparent to one skilled in the art that the present disclosure may be carried out using a large number of variations of the devices, device components, and methods steps set forth in the present description. As will be obvious to one of skill in the art, methods and devices useful for the present methods can include a large number of optional composition and processing elements and steps. Accordingly, the embodiments disclosed and/or claimed herein are intended to embrace all such modifications and variations that fall within the spirit and scope of the appended claims.

Whenever a range is given in the specification, for example, a temperature range, a time range, a relative humidity range, or a composition or concentration range, all intermediate ranges and subranges, as well as all individual values included in the ranges given are intended to be included in the disclosure. It will be understood that any subranges or individual values in a range or subrange that are included in the description herein can be excluded from the aspects herein.

Although the present disclosure has been described with reference to certain embodiments thereof, other embodiments are possible without departing from the present disclosure. The spirit and scope of the appended aspects should not be limited, therefore, to the description of the preferred embodiments contained herein. All embodiments that come within the meaning of the aspects, either literally or by equivalence, are intended to be embraced therein. Furthermore, the advantages described above are not necessarily the only advantages of the disclosure, and it is not necessarily expected that all of the described advantages will be achieved with every embodiment of the disclosure.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative (rather than in a restrictive) sense.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Various other components and functions (whether alone, in place of, or in combination with the components and functions described herein) can be used in energy harvesting and/or self-powered sensing devices utilizing natural porous materials, such as for triboelectric nanogenerator.

What is claimed is:

1. A triboelectric device comprising:
a device body including organic material and multiple layers of material, wherein electrical energy is generated responsive to mechanical energy being applied to the device body.

2. The triboelectric device of claim 1, wherein at least one of: the organic material comprises pomelo peel, the pomelo peel is utilized with a conductive layer and/or a substrate, another triboelectric layer includes a conductive layer and a substrate, and/or one or more spacers are utilized to separate different triboelectric layers.

3. The triboelectric device of claim 1, wherein the multiple layers of material comprise at least one of copper, acrylic, a polyimide film, a polytetrafluoroethylene layer, or a combination thereof.

4. The triboelectric device of claim 1, wherein the multiple layers of material comprise a conductor and an insulator.

5. The triboelectric device of claim 1, wherein the mechanical energy comprises at least one of a vertical force, an inclined force, or a lateral force applied to the device body.

6. The triboelectric device of claim 1, wherein the device body is encapsulated in a material that is selected to mitigate moisture evaporation or loss, and wherein the encapsulated device body prevents environmental moisture from affecting the performance of the device.

7. The triboelectric device of claim 1, further comprising an interface for connecting to an electrical component.

8. The triboelectric device of claim 7, wherein the electrical component stores, or displays the electrical energy as a signal or the signal is stored on a computing device.

9. The triboelectric device of claim 8, wherein the signal is configured for facilitating detection or monitoring of motion of a user that is wearing the triboelectric device.

10. The triboelectric device of claim 7, wherein operations of the electrical component are powered by the electrical energy.

11. A method comprising:
integrating a triboelectric device into an object that is subjected to mechanical energy, the triboelectric device comprising a device body including organic material and multiple layers of material; and
connecting the triboelectric device to an electrical component,
wherein, when the mechanical energy is applied to the device body, electrical energy is generated and provided to the electrical component.

12. The method of claim 11, wherein at least one of: the organic material comprises pomelo peel, the pomelo peel is utilized with a conductive layer and/or a substrate, another triboelectric layer includes a conductive layer and a substrate, and/or one or more spacers are utilized to separate different triboelectric layers, and/or one or more spacers are utilized to separate different triboelectric layers.

13. The method of claim 11, wherein the organic material comprises pomelo peel, and wherein the multiple layers of material include a conductor and an insulator comprising at least one of copper, acrylic, a polyimide film, a polytetrafluoroethylene layer, or a combination thereof.

14. The method of claim 11, wherein the electrical component stores or displays the electrical energy as a signal or the signal is stored on a computing device.

15. The method of claim 14, further comprising analyzing the signal to detect or monitor motion of a user that is wearing the object.

16. The method of claim 11, wherein operations of the electrical component are powered by the electrical energy.

17. A method comprising:
obtaining pomelo peel;
punching the pomelo peel into a particular size and shape resulting in a pomelo disc;
polishing a surface of the pomelo disc; and
combining the pomelo disc with multiple layers of material to create a device body for a triboelectric device.

18. The method of claim 17, further comprising:
integrating the triboelectric device into an object that is subjected to mechanical energy; and
connecting the triboelectric device to an electrical component, wherein when the mechanical energy is applied to the device body electrical energy is generated and provided to the electrical component.

19. The method of claim 17, further comprising at least one of cutting pomelo peel or freeze drying the pomelo disc, wherein the multiple layers includes a conductive layer and/or a substrate, and/or wherein another triboelectric layer includes a conductive layer and a substrate, and wherein the conductor or the insulator comprises at least one of copper, acrylic, a polyimide film, a polytetrafluoroethylene layer, or a combination thereof, and/or one or more spacers are utilized to separate different triboelectric layers.

20. The method of claim 18, further comprising:
providing the device body with an interface for connection with an electrical component, wherein the electrical energy is used to detect or monitor motion of a user that is wearing the object or wherein operations of the electrical component are powered by the electrical energy.
